(19) United States
(12) Patent Application Publication
(10) Pub. No.: US 2009/0026870 A1
(43) Pub. Date: Jan. 29, 2009

(54) FUSING STRUCTURE OF MOTOR

(75) Inventors: Akinori HOSHINO, Nisshin-shi (JP); Haruji Suzuki, Kariya-shi (JP); Shusaku Kamio, Nishio-shi (JP)

Correspondence Address: SUGHRUE MION, PLLC, 2100 PENNSYLVANIA AVENUE, N.W., SUITE 800, WASHINGTON, DC, 20037, US

(73) Assignee: AISIN SEIKI KABUSHIKI KAISHA, Kariya-shi (JP)

(21) Appl. No.: 12/177,459

(22) Filed: Jul. 22, 2008

(30) Foreign Application Priority Data
Jul. 26, 2007 (JP) 2007-194027

(51) Int. Cl. H02K 3/00

(52) U.S. Cl. 310/194

(57) ABSTRACT

A fusing structure of a motor, includes a stator and a rotor, wherein the bus ring includes a ring portion and a fusing hook, and the bobbin includes a first engagement portion for changing a direction of an end portion of the wire extending from the coil so as to supply the coil with the power and a second engagement portion guiding the end portion of the wire and formed in a different length from that of the first engagement portion in the radial direction of the motor, the end portion of the wire is held between the first engagement portion and the second engagement portion so as to incline therebetween and held between the opposing surfaces so as to establish an electrical connection with the bus ring.

### CROSS REFERENCE TO RELATED APPLICATIONS

This application is based on and claims priority under 35 U.S.C. §119 to Japanese Patent Application 2007-194027, filed on Jul. 26, 2007, the entire contents of which is incorporated herein by reference.

### FIELD OF THE INVENTION

The present invention relates to a fusing structure of a motor.

### BACKGROUND

A known fusing structure of a motor is disclosed in JP2005-229677A (which is hereinbelow referred to as reference 1). In a bus ring of a motor connecting identical-phase motor coils the bus ring is formed out of at least one conductor wire, and a terminal portion of the bus ring, connected to a winding end of the motor coil, is bent in a U-shape so that opposing surfaces of the bus ring contact tightly each other in order to form an cohesive terminal. The fusing structure includes a fusing terminal that supports and is fused to the cohesive terminal of the bus ring and the winding end of the motor coil. The fusing terminal includes a U-shaped portion whose width is extending in a direction of an axis of the motor so as to dispose the cohesive terminal of each phase between opposing walls of the fusing terminal. In such a structure, the fusing terminal and the cohesive terminal are fused (resistance welding). The opposing wall of the fusing terminal to the cohesive terminal of the bus ring is formed to have a protrusion portion at an inner surface and a recessed portion at an outer surface.

Another known using structure is disclosed in JP2002-369453A (which is hereinbelow referred to as reference 2). In the fusing structure disclosed in reference 2, a commutator of a rotation motor includes an approximately cylindrically-formed insulator made of resin, a plurality of segments, arranged on an outer circumference of the insulator and a connection tab to which the wire is fused. In a fusing terminal of the commutator, a thickness of a portion of the segment corresponding to the connection tab is formed to be thinner than a thickness of another portion of the segment and the circumferential width of a portion of the segment corresponding to the connection tab is formed to be narrower than a width of a portion where a brush slidably contacts. A protrusion is formed so as to avoid a portion around the connection tab. In such a structure, the fusing terminal and a winding end of the wire are connected by the fusing.

Further, another known fusing structure is disclosed in JP2001-267124A (which is hereinbelow referred to as reference 3). The fusing structure disclosed in reference 3 includes an electromagnetic valve coil in which a packaged insulating member of a bobbin, having a winding end terminal and a winding start terminal, which are connected to protruding conductor wires of the electromagnetic valve, is covered by synthetic resin molding. Projected stoppers are provided on end portions of arm portions of the winding end and winding start terminals. When the arm portions are respectively bent to fix end portions of the conductor wire by caulking, crushing amount of the end portions of the wire is regulated by the stoppers.

In the fusing structure disclosed in reference 1, the cohesive terminal of the bus ring contacts and is supported by the opposing wall of an cohesive terminal holding portion provided at the fusing terminal in a direction vertical to a line connecting center points of orthogonal cross sections of the two conductor wires of the cohesive terminal relative to a longitudinal direction thereof. In such a manner, the cohesive terminal and the cohesive terminal holding portion are fused. However, when fusing, it is difficult to maintain the line connecting center points to be orthogonal relative to the opposing wall of the cohesive terminal holding portion and the cohesive terminal may be inclined relative to the cohesive terminal holding portion when fusing, or the cohesive terminal formed in U-shape and the conductor wire may slip against each other at a contact portion therebetween. Thus, a gap may be generated between the opposing wall of the cohesive terminal holding portion and the cohesive terminal, and the opposing wall may not to be fused with the cohesive terminal, thus resulting in a malfunction of the cohesive terminal holding portion and the cohesive terminal not being fused sufficiently. When pressing the opposing wall of the cohesive terminal holding portion provided at the fusing terminal by electrodes for fusing in order to close the gap mentioned above, end portions of the opposing wall of cohesive terminal holding portion may contact each other. In a case where some of the end portions of the opposing wall contact each other and other of the end portions of the opposing wall do not contact the cohesive terminal, a condition of fusing fluctuates, therefore, the opposing wall and the cohesive terminal may not fused appropriately.

As the fusing terminal has a complex shape, and further, the cohesive terminal holding portion includes a protruding portion at the inner surface of the opposing wall, a number of portions, which are manufactured, and are increased, thus resulting in an increase of cost for manufacturing the fusing structure disclosed in reference 1. Accordingly, a cost of the fusing terminal is also increases.

In the commutator of the fusing structure in reference 2, a base end portion of the connection tab is bent so as to place an end portion of the connection tab on a holding portion of the commutator, and provide the wire through the holding portion In such condition, the connection tab is pressed and being weld to the wire by fusing. In this case, an extraneous material, such as dust, may be included between the end portion of the connection tab and the holding portion of the commutator, or dimension of the opposing surface of the end portion of the connection tab and pressure of pressing the opposing surface may differ depending on the bending condition. As a result, an inductance at a connecting portion between the opposing surfaces and the holding portion may not be maintained to be constant. When the inductance varies, the connection tab and the wire may not be fused appropriately and a defective fusing structure may be produced.

Further, the portion of the segment in vicinity of the connection tab is formed to be thinner than the other portions of the segment, the width of the segment in the circumferential direction thereof in vicinity of the connection tab is formed to be narrower than the width of a portion where a brush slidably contacts and the protrusion is provided so as to avoid the portion in vicinity of the connection tab. Therefore, the structure of the segment of the commutator including the connection tab, the holding portion and the portion where the brush slidably contacts becomes complex. As a result, the cost of the fusing terminal is increased for the similar reason mentioned above.

In the fusing structure of the electromagnetic valve disclosed in reference 3, the arm portion of the terminal is bent to hold the end portion of the conductor wire, the end portion of the conductor wire is fixed at the arm portion by caulking and then, the arm portion of the terminal and the end portion of the conductor wire are connected by the fusing. The stopper in the protruding shape is provided at the end portion of the arm portion of the terminal in order to maintain the crushing amount of the end portion of the conductor coil to be constant. In this case, an extraneous material, such as dust, may be included between the stopper and a surface opposing to the stopper, or the pressure of pressing the opposing face of the stopper may vary depending on a bending condition. Therefore, for the similar reason mentioned above, an inductance at a connecting portion of the stopper may not be maintained to be constant, which may result in fluctuating a condition of appropriate fusing. Accordingly, in a case where the terminal and the wire are fused under a certain condition, the arm portion of the terminal and the end portion of the conductor wire may not be appropriately fused.

A need thus exists for a fusing structure of a motor which is not susceptible to the drawback mentioned above.

### SUMMARY OF THE INVENTION

According to an aspect of the present invention, a fusing structure of a motor, includes a stator including a stator core formed in a ring shape, a coil formed by winding a wire around the stator core via a bobbin and a bus ring connected to the stator core for supplying power to the coil and a rotor provided along an inner circumference of the stator and rotating relative to the stator when the coil is supplied with power from the bus ring, wherein the bus ring includes a ring portion and a fusing hook formed by bending a plate portion in a U-shape to form opposing surfaces being arranged in a radial direction of the motor, and the bobbin includes a first engagement portion for changing a direction of an end portion of the wire extending from the coil so as to supply the coil with the power and a second engagement portion guiding the end portion of the wire and formed in a different length from that of the first engagement portion in the radial direction of the motor, the end portion of the wire is held between the first engagement portion and the second engagement portion so as to incline therebetween and held between the opposing surfaces of the fusing hook so as to establish an electrical connection with the bus ring.

According to another aspect of the present invention, a fusing structure of a motor, includes a coil provided inside the motor and a fusing hook establishing a electrical connection with the end portion of the wire extending from the coil so as to supply power to the coil, wherein a plate portion is bent to form a free end of the fusing hook and to hold the end portion of the wire between the opposing surfaces formed by bending the plate portion, thereby establishing an electrical connection between the opposing surfaces and the end portion of the wire.

### BRIEF DESCRIPTION OF THE DRAWINGS

The foregoing and additional features and characteristics of the present invention will become more apparent from the following detailed description considered with the reference to the accompanying drawings, wherein:

FIG. 1 is a cross-sectional view illustrating a fusing structure according to an embodiment of a present invention.

FIG. 2 is a plain view illustrating a power supply unit according to the embodiment of the present invention,

FIG. 3A is a cross-sectional view illustrating the power supply unit taken along line IIIA-IIIA in FIG. 2.

FIG. 3B is a cross-sectional view illustrating the power supply unit taken along line IIIB-IIIB in FIG. 2.

FIG. 3C is a cross-sectional view illustrating the power supply unit taken along line IIIC-IIIC in FIG. 2.

FIG. 3D is a cross-sectional view illustrating the power supply unit taken along line IIID-IIID in FIG. 2.

FIG. 4 is a cross-sectional view illustrating an electromagnet provided at a stator according to the embodiment of the present invention.

FIG. 5 is an enlarged perspective view illustrating a winding of the fusing structure in FIG. 4 according to the embodiment of the present invention.

### DETAILED DESCRIPTION

An embodiment of a fusing structure of a motor according to the present invention is described hereinbelow with reference to the attached drawings.

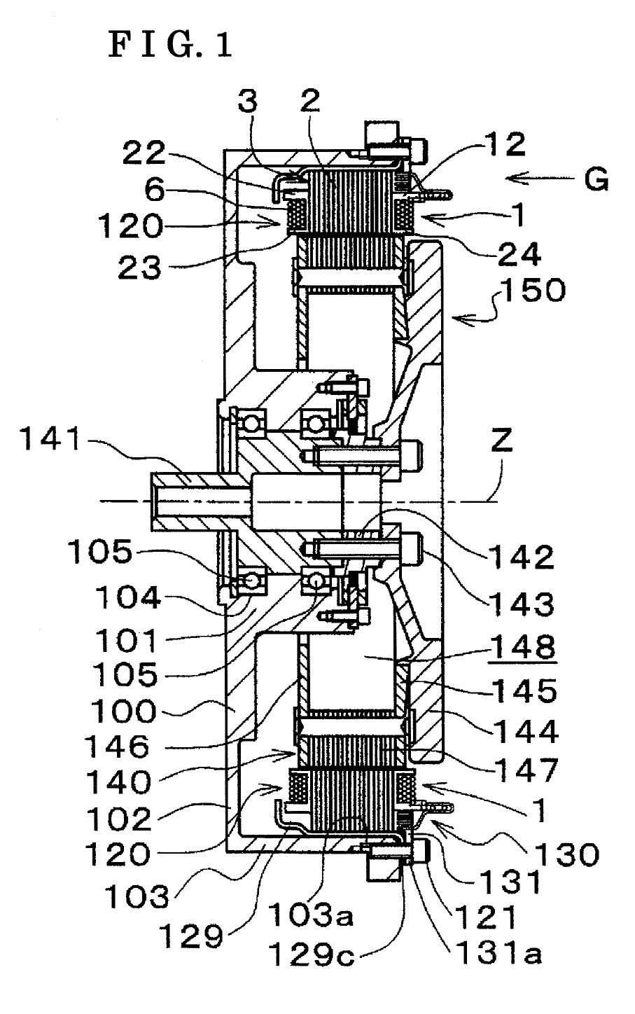

FIG. 1 illustrates a cross section of a motor 150 which includes a fusing structure according to an embodiment of the present invention. The motor 150 includes a housing (base portion) 100, a stator 120 which is supported at the housing 100, a rotor 140 which generates a rotation torque by rotating relative to the stators 120, and a ring-shaped power supply unit 130 which supplies power to coils 6 of electromagnets 1 provided at the stator 120.

The housing 100 includes a boss portion 101 provided at the center thereof, a circular plate portion 102 provided so as to extend from the boss portion 101 in a radial direction thereof and a cylinder portion 103 provided at the circumference end of the circular portion so as to extend parallel to an axis of the boss portion 101.

The rotor 140 includes a rotation shaft 141 supported by a bearing 105 which is provided at a center hole 104 of the boss portion 101, a plate 144 connected to an end of the rotation shaft 141 by means of connecting bolts 143 via a connection member 142, end plates 145, 146 supported by the plate 144 so as to face each other, a laminated core 147 which is a lamination of magnetic plates provided between the end plates 145, 146, a permanent magnet (not illustrated in the drawings) embedded in the laminated core 147 and a space 148.

The stator 120 is structured with a plurality of the electromagnets 1 arranged along a circumference of a stator holder 129.

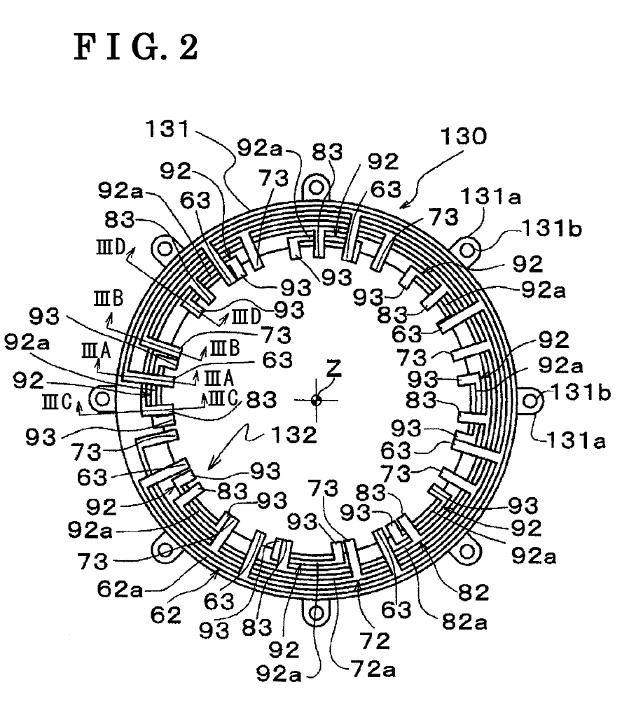

FIG. 2 is a plain view illustrating the power supply unit 130 according to the embodiment of the present invention, when being viewed in the direction shown as G in FIG. 1. As illustrated in FIG. 2, the power supply unit 130, functioning as a bus ring and formed in a ring shape, includes a bus ring group 132 and an insulating holder 131. The bus ring group 132 includes bus rings formed in various ring-plate shapes as conductive path. The insulating holder 131 is formed in a ring shape so as to hold the bus ring group 132. A plurality of connecting portions 131a including first insertion holes 131b are provided at a circumference of the insulating holder 131.

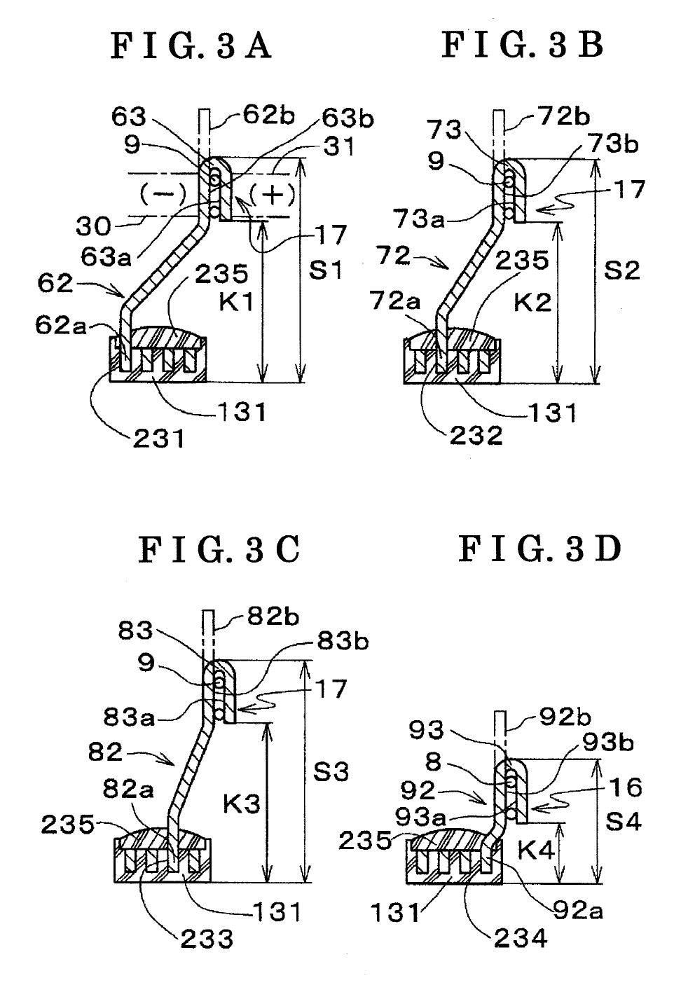

The bus ring group 132 includes a first bus ring 62 (a bus ring) which is electrified with a U-phase electric current of a three-phase alternating current, a second bus ring 72 (a bus ring) which is electrified with a V-phase electric current, a third bus ring 82 (a bus ring) which is electrified with a W-phase electric current and a neutral bus ring 92 (a bus ring). The coils 6 are supplied with power through the winding start and winding end (end portion of wire) 8,9 (illustrated in FIGS. 3, 4 and 5). Each of the bus rings 62,72,82 and 92 has the same thickness, is flexible and is made mainly of a conductive material. The conductive material here may or may not be coated by insulating coating, however in this embodiment, a surface of the conductive material is tinned.

Each of the ring-shaped first bus ring 62, second bus ring 72, third bus ring 82 and neutral bus ring 92 includes each of a first bus ring portion 62a (a ring portion), a second bus ring portion 72a (a ring portion), a third bus ring portion 82a (a ring portion) and a neutral bus ring 92a (a ring portion), each of which are formed by pressing a thin plate material and bent into a band shape.

FIG. 3A illustrates a cross section of the power supply unit 139 taken along line IIIA-IIIA in FIG. 2 and similarly FIG. 3B illustrates a cross section of the power supply unit 139 taken along line IIIB-IIIB, FIG. 3C illustrates a cross section of the power supply unit 139 taken along line IIIC-IIIC and FIG. 3D illustrates a cross section of the power supply unit 139 taken along line IIID-IIID. FIG. 3A mainly illustrates a cross section of the first bus ring 62 whose first bus ring portion 62a is fit into a first engagement groove 231 provided at the insulating holder 131. Similarly, as FIGS. 3B, 3C and 3D illustrate, the second bus ring portion 72a of the second bus ring 72 is fit into a second engagement groove 232 provided at the insulating holder 131, the third bus ring portion 82a of the third bus ring 82 is fit into a third engagement groove 233 provided at the insulating holder 131 and the neutral bus ring portion 92a of the neutral bus ring is fit into a neutral engagement groove 234 provided at the insulating holder 131. As illustrated in FIG. 2, a circumference of the neutral bus ring 92 is formed to be shorter than circumferences of the first bus ring 62, the second bus ring 72 and the third bus ring 82. Further, each of the engagement grooves 231, 232, 233 and 234 is arranged concentrically (substantially concentrically) relative to a rotational axis Z (illustrated in FIGS. 1 and 2 and will be described below) of tie rotor 140 which rotates relative to the stator 120.

After fitting each of the bus rings 62, 72, 82 and 92 into each of the corresponding engagement grooves 231, 232, 233 and 234, an insulating seal member 235 is provided to cover gaps between each of the first, second, third and neutral ring portions 62a, 72a, 82a and 92a of the bus rings 62, 72, 82 and 92 so as to seal and fix each of the bus rings 62, 72, 82 and 92.

The first bus ring 62, the second bus ring 72, the third bus ring 82 and the neutral bus ring 92 are provided in this order from an outer to an inner circumference of the power supply unit 130. The first bus ring 62 is arranged at the outermost position at an outer circumference side of the power supply unit 130, the second bus ring 72 is arranged at an inner circumference of the first bus ring 62, the third bus ring 82 is arranged at a further inner circumference of the second bus ring 72 and the neutral bus ring 92 is arranged at the innermost position at an inner circumference side of the power supply unit 130.

Further as illustrated in a dashed line in FIGS. IIIA, IIIB IIIC and IIID, a plurality of plate portions 62b, 72b, 82b and 92b protrude from the first ring portion 62a, the second ring portion 72a, the third ring portion 82a and the neutral ring portion 92a, respectively.

S1 represents a height from a bottom surface of the insulating holder 131 to a first fusing hook 63 (a fusing hook) of the first bus ring 62, S2 represents a height from the bottom surface of the insulating holder 131 to a second fusing hook 73 (a fusing hook) of the second bus ring 72, and S3 represents a height from the bottom surface of the insulating holder 131 to a third fusing hook 83 (a fusing hook) of the third fusing hook 82. The heights S1, S2 and S3 are set to equal to each other, or substantially equal to each other. K1 represents a height from the bottom surface of the insulating holder 131 to an insulating end portion of the fusing hook 63, K2 represents a height from the bottom surface of the insulating holder 131 to an insulating end portion of the fusing hook 73 and K3 represents a height from the bottom surface of the insulating holder 131 to an insulating end portion of the fusing hook 83. The heights K1, K2 and K3 are set to be equal to each other, or substantially equal to each other. S4 represents a height from the bottom surface of the insulating holder 131 to a neutral fusing hook 93 (a fusing hook) of the neutral bus ring 92. The height S4 is set to be shorter than the heights S1, S2 and S3. K4 represents a height from the bottom surface of the insulating holder 131 to an insulating end portion of the fusing hook 93. The height S4 is set to be shorter than the heights K1, K2 and K3. Further, as illustrated in FIG. 1, the stator 120 is structured by arranging a plurality of the electromagnets 1 at a circumference of the stator holder 129.

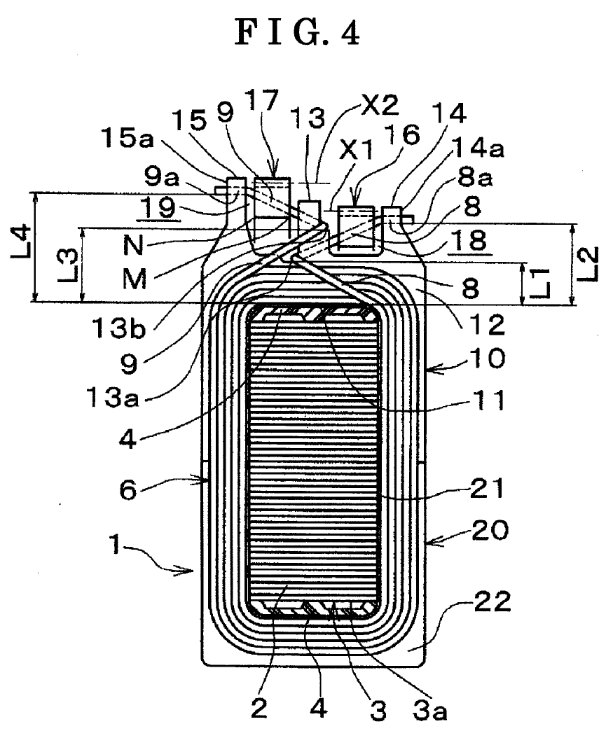

FIG. 4 illustrates a cross section of one of the electromagnets 1 which is provided at the stator 120 according to the embodiment related to the present invention. A structure of each of the electromagnets 1 for the U-phase, the V-phase and the W-phase are substantially the same. Therefore, one of the electromagnet 1 for the U-phase will be mainly described hereinbelow as an example. As illustrated in FIG. 4, the electromagnet 1 includes a stator core 3, bobbins 10 and 20 and the coil 6. The ring-shaped stator core 3 is formed by laminating magnetic metal plates 2. The nonmagnetic bobbins 10 and 20 include substantially U-shaped cylinder portions 11 and 12 respectively which hold the stator core 3 in a laminated direction via a nonmagnetic spacer 4 so as to be structured substantially symmetrical about the bobbins 10 and 20. Further, the coil 6 is formed by winding a copper-made conductor wire at circumferences of the cylinder portions 11 and 12. Collar portions 12 and 24 (illustrated in FIG. 1) are provided at the cylinder portion 11 of the bobbin 10 at both sides of the bobbin 10 in a radial direction of the motor 150, and similarly collar portions 22 and 23 (illustrated in FIG. 1) are provided at the cylinder portion 21 of the bobbin 20 at both sides of the bobbin 20 in the radial direction of the motor 150. Teeth portions 3a of the stator core 3 penetrate through inner portions of the cylinder portions 11 and 21. The collar portions 12, 22, 23 and 24 limit lengths of the coil 6 in a direction substantially orthogonal relative to a winding axis of the coil 6. An outer surface of the coil 6 is coated with an insulator and the coil 6 includes a winding start 8 at one end portion of the coil 6 and a winding end 9 at the other end portion of the coil 6 for supplying a power. The insulating coating is striped from a power-supplying portion of the winding start 8, so that the power is supplied from a terminal portion of the winding start 8.

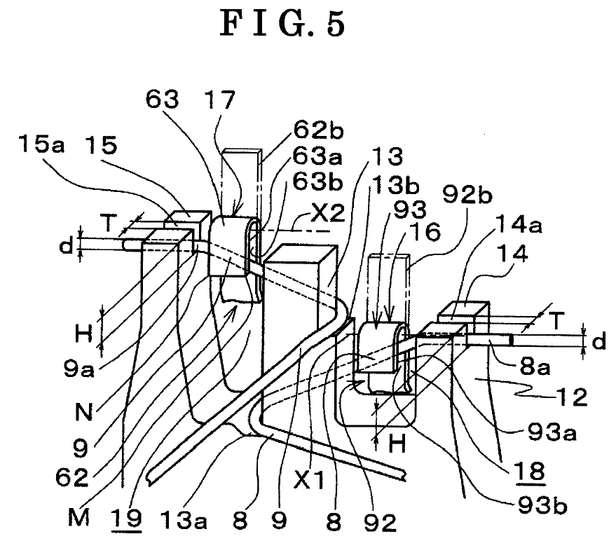

FIG. 5 is an enlarged perspective view illustrating a manner of winding at the fusing structure of the electromagnet 1 which is illustrated in FIG. 1 according to the embodiment of the present invention. A first engagement member 13 is provided at a center portion of the collar 12, a seat portion 13a (a first engagement portion) is provided at a base portion of the first engagement member 13 and the winding start 8 engages with the seat portion 13a by being wound thereat to form a substantially V shape. Similarly, a seat portion 13b (a first engagement portion) is provided at a middle portion of the first engagement member 13 so that the first engagement member 13 forms a stepwise shape and the winding end 9 engages with the seat portion 13b by being wound thereat to form a substantially V shape. The seat portions 13a and 13b may also be other form, such as grooves and the winding start 8 and the winding end 9 may fit in the groove, instead of engaging with the seat portions 13a and 13b respectively as shown in this embodiment.

Second engagement members 14 and 15 are provided at both sides of the collar portion 12, positioning the first engagement member 13 therebetween. Lengths of the second engagement member 14 and the first engagement member 13 in the radial direction of the motor 150 are set to be different from each other. A groove 14a (a second engagement portion) with which a terminal portion 8a of the winding start 8 engages, or into which the terminal portion 8a fits, is provided at the second engagement members 14. A groove 15a (a second engagement portion) with which a terminal portion 9a of the winding end 9 engages, or into which the terminal portion 9a fits, is provided at the second engagement member 15. Widths T of the grooves 14a and 15b and widths of the seat portions 13a and 13b in radial direction of the motor 150 are different. Widths T of the grooves 14a and 15a are set to be shorter than widths of the seat portions 13a and 13b in the radial direction of the motor 150 so as to hold the winding end 9 to be inclined therebetween.

Widths T of the groove portions 14a and 15a are set to be narrower than diameters d of the terminal portion 8a of the winding start 8 and the terminal portion 9a the winding end 9, respectively. Depths H of the groove portions 14a and 15a is set to be deeper than radiuses d/2 of the terminal portions 8a of the winding start 8 and the terminal portion 9a of the winding end 9, respectively. Therefore, the terminal portion 8a of the winding start 8 and the terminal portion 9a of the winding end 9 are disposed into the grooves 14a and 15a respectively so that the terminal portion 8a of the winding start 8 and the terminal portion 9a of the winding end 9 are guided therein. The winding start 8 and the winding end 9 are properly stretched by pulling the terminal portions of 8a and 9a which are fit into the grooves 14a and 15a.

A configuration space 19 in which the first fusing hook 63 is arranged is provided between the first and second engagement members 13 and 15, and a configuration space 18 in which the neutral fusing hook 93 is arranged is provided between the first and second engagement members 13 and 14. The V-phase electromagnet 1 and the W-phase electromagnet I are structured substantially the same as the U-phase electromagnet 1. More specifically, for the V-phase electromagnet 1, a configuration space 19 in which the second fusing hook 73 is arranged is provided between the first and second engagement members 13 and 15, and a configuration space 18 in which the neutral fusing hook 93 is arranged is provided between the first and second engagement members 13 and 14. Further for the W-phase electromagnet 1, a configuration space 19 in which the second fusing hook 83 is arranged is provided between the first and second engagement members 13 and 15, and a configuration space 18 in which the neutral fusing hook 93 is arranged is provided between the first and second engagement members 13 and 14.

As illustrated in FIG. 4, a distance L2 from a portion where the terminal portion 8a of the winding start 8 fits into the groove 14a to a base portion of the cylinder portion 11 of the bobbin 10 is set to be longer than a distance L1 from a portion where a middle portion of the winding start 8 engages with the seat portion 13a to the base portion of the cylinder portion 11 of the bobbin 10. Here, the base portion of the cylinder portion 11 refers to the portion at which the collar 12 is formed. Similarly, a distance L4 from a portion where the terminal portions 9a of the winding end 9 fits into the groove 15a to the base portions of the cylinder portion 11 of the bobbin 10 is set to be longer than a distance L3 from a portion where a middle portion of the winding start 9 engages with the seat portion 13b to the base portion of the cylinder portion 11 of the bobbin 10.

As illustrated in FIG. 1, bolts 121 are inserted into the first insertion holes 131b (illustrated in FIG. 2) provided at the connecting portions 131a of the insulating holder 131 and into second insertion holes 129c provided at the stator holder 129 of the stators 120 and further screwed into screw holes 103a provided at the cylinder portion 103 of the housing 100. Accordingly, the ring-shaped power supply unit 130 is provided at an outer circumference side of the rotor 140 and further at outer circumference sides of the winding starts 8 and the winding ends 9 of the coils 6 provided at the electromagnets 1 which are connected electrically with the power supply units 130. The stator 120 is removably attached at the housing 100 in the concentric manner (or substantially concentric manner) relative to the rotor 140 with clearance in the radial direction of the rotor 140 between the stators 120 and the rotor 140. A plurality of electromagnets 1 are arranged to provide wires for the U-phase, the V-phase and the W-phase of the three-phase alternating current at the corresponding coils 6 so as to generate rotating magnetic fields at the stators 120.

As illustrated in FIG. 5, for one of the electromagnets 1 for U-phase, the plate portion 62b (illustrated with a dashed-line) is bent on a bending axis X2 so as to substantially form a U-shape in order to form the first fusing hook 63. Corner portions M and N of the fusing hook 63 are provided at an end portion of a free end. Defining left and right sides of an opposing surface 63a of the first fusing hook 63 in a width direction (M-N direction) as first and second sides respectively, the winding end 9 which is held between the seat portion 13b and the groove 15a extends through the end portion of the free end including the first and second sides (e.g. towards the corner portion N). More specifically, the winding end 9 is held between the first surface 63a and a second surface 63b so as to incline while forming an angle relative to the bending axis X2. In such a state, the opposing surfaces 63a and 63b are connected to the winding end 9 by fusing, thereby forming a fusing terminal 17 in which the first and second opposing surfaces 63a and 63b of the first fusing hook 63 are connected to the winding end 9, so that an electrical connection is established therebetween. Similarly, the plate portion 92b (illustrated with a dashed-line) is bent on a bending axis X1 in substantially U-shape in order to form the neutral fusing hook 93. The winding start 8 extending through the seat portion 13a and the groove 14a is held between a first and second surfaces 93a and 93b. In such a state, the winding start 8 and the first and second opposing surfaces 93a and 93b, which are spaced away from each other, are connected by fusing thereby forming a neutral fusing terminal 16 in which the first and second opposing surfaces 93a and 93b of the neutral fusing hook 93 are connected to the winding start 8. In this case also, the winding start 8 is held between the first and second opposing, surfaces 93a and 93b at so as to incline while forming an angle relative to the axis X1. A plurality of the fusing terminals 16 and 17 are provided in the concentric manner (substantially concentric manner) relative to the rotational axis Z of the rotor 140. Likewise, the V-phase and the W-phase wires are structured substantially the same, and the fusing terminals 17 are provided at the V-phase fusing hooks 73 and the W-phase fusing hooks 83, as illustrated in FIGS. 3B and 3C.

According to the embodiment, after being provided at the configuration space 19, the plate portion 62b of the first bus ring 62 is bent in the substantially U-shape so as to form the first fusing hook 63 and in such a state the fusing terminal 17 is formed by holding the winding end 9 which is held in the configuration space. Alternatively, the first fusing hook 63 which is already formed in the substantially U-shape may be provided at the configuration space 19 and in such a state, the winding end 9 may be connected to the first and second opposing surfaces 63a and 63b by fusing so as to form the fusing terminal 17. In other words, an order of forming the fusing terminal 17 is not limited to the order described in the embodiment.

Further, the motor 150 may be used as a generator when not used as a motor.

Functions and advantages the motor having the above-described fusing structure according to the embodiment will be described hereinbelow. Functions and effects of the fusing terminals 16 and 17 are the same, therefore, the function and effect of one of the fusing terminal 17 will be described hereinbelow as an example and the description of the function and effect of the fusing terminal 16 will not be given. Further, functions and effects of the U-phase, the V-phase and the W-phase are the same, therefore, the function and effect of one of the U-phase will be described as an example hereinbelow.

As illustrated in FIG. 3A, outer surfaces of the opposing surfaces 63a and 63b are pressed by the predetermined pressing force with the positive electrode 31 (illustrated in a dashed line) and the negative electrode 30 (illustrated in a dashed line) respectively by a predetermined pressing force and when the positive electrode 31 and the negative electrode 30 are electrified with a predetermined amount of electricity for a predetermined time, the opposing surfaces 63a and 63b generate heat. The heat is conducted to the winding end 9 which is held between the opposing surfaces 63a and 63b, and the insulating coating of the winding end 9 is. Thus, the opposing surfaces 63a and 63b of the first fusing hook 63 is connected to the winding end 9 by fusing, thereby forming the fusing terminal 17.

As the winding end 9 which is held between the opposing surfaces 63a and 63b is provided so as to incline while forming an angle relative to the bending axis X2 of the first fusing hook 63, one end of the winding end 9 which is held between the opposing surfaces 63a and 63b is positioned at the free end (an angled portion, either M or N) of the plate portion 62b. However, a position where the one end of the winding end 9 is provided is not limited to an acute end of the free end, but the one end of the winding end 9 may also be provided at a position away from the free end for a distance by which the opposing surfaces 63a and 63b are not weld to each other when being fused. For example, the one end of the winding end 9 may be provided at a position above the acute end of the free end (towards the bending axis X2) for a distance shorter than the diameter of the winding end 9. In other words, a portion which is not welded may extend from the free end as long as the portion extending from the free end is shorter than the diameter of the winding end 9. Further, the winding end 9 may not be necessarily inclined while forming an angle relative to the rotational axis Z as long as the free ends of the corner portions M and N are arranged so as not to be welded with the opposing surface 63b. For example, the winding end 9 may be provided between the opposing surfaces 63a and 63b so as to be arranged in parallel to the width direction (M-N direction) at a position closer to a bent portion of the fusing hook 63 from an end portion thereof (i.e. towards the bending axis X2 so that a distance from a line connecting the corner portions MN to a bottom portion of a circumference of the winding end 9 is shorter than the diameter of the winding end 9. When fusing, by pressing the positive electrode 31 and the negative electrode 30 by the predetermined force from the outer sides of the opposing portions 63a and 63b, respectively, the winding end 9 which is held between the opposing faces 63a and 63b is pressed appropriately and as result, the winding end 9 appropriately contacts with the opposing surfaces 63a and 63b. Therefore, the inner surfaces of the opposing surfaces 63a and 63b, provided at the first fusing hook 63, press the winding end 9 sufficiently so as to establish an electrical connection therebetween.

Further, the winding end 9 which is held between the opposing surfaces 63a and 63b is not formed in a U-shaped cohesive wire used in the prior art, therefore, the winding end 9 does not need to be provided between the opposing surfaces 63a and 63b so as to maintain a line connecting the center points of two cohesive conductor wires to be orthogonal to an opposing wall of an cohesive terminal holding portion, and the winding end 9 may be prevented from slipping against the opposing surfaces 63a and 63b when fusing. Therefore, according to the embodiment, even if the outer surfaces of the opposing surfaces 63a and 63b are pressed with the positive electrode 31 and negative electrode 30, respectively, the opposing surfaces 63a and 63b are prevented from contacting each other, which occurs in the known art where the U-shape formed cohesive wire is fused with the opposing walls.

A condition of fusing will be now described. According to a measurement, when the opposing surfaces 63a and 63b of the fusing terminal 17 do not contact each other, a primary current and a secondary current supplied to the positive electrode 31 and the negative electrode 30 are 3500 A and 7000 A respectively. When the opposing surfaces 63a and 63b of the fusing terminal 17 contact each, the primary current and the secondary current supplied to the positive electrode 31 and the negative electrode 30 are 4000 A and 6500 A respectively. A different current is the result of a different inductance between the opposing surfaces 63a and 63b. When conditions of a contact between the opposing surfaces 63a and 63b varies from portion to portion, a value of the primary current fluctuates from 3500 A to 4000 A and a value of the secondary current fluctuates from 4500 A to 7000 A. The values of the current fluctuate depending on the pressure force between the inner surfaces of the opposing surfaces 63a and 63b and also on condition of dimensions therebetween, that is, condition of inductance therebetween. However, when the opposing surfaces 63a and 63b do not contact each other, the primary and secondary current supplied to the positive electrode 31 and the negative electrode 30 is maintained to be substantially constant.

For a reason described above, when fusing, a distance between the opposing surfaces 63a and 63b is maintained to be constant so as to prevent the opposing surface 63a of the fusing terminal 17 from contacting the opposing surface 63b, therefore, the opposing surfaces 63a and 63b of the first fusing hook 63 and the winding end 9 which is held between the opposing surfaces 63a and 63b are connected stably and appropriately by fusing under a constant condition.

Further, in order to form the fusing terminal 17, the plate portion 62b is bent so as to have the substantially U-shaped cross-section and the winding end 9 is stabilized at the seat portion 13b formed at the bobbin 10, the winding end 9 is hold between the seat portion 13b and the groove 15 so as to extend therebetween and then the winding end 9 is connected to the opposing surfaces 6a and 63b. Therefore, the above-described fusing structure of a motor is simplified and the number of portions manufactured is reduced, when compared to the known art. Further, a process of pressing the opposing surface 63a on the opposing surface 63b is not needed. As a result, the cost of the fusing terminal 17 is decreased.

Still further, as illustrated in FIGS. 3A 3B 3C and 3D, the one end of the winding end 9 which is held between the opposing surfaces 63a and 63b is provided at the corner portion M (see FIG. 5) which is positioned at an end portion of the opposing surface 63a relative to the bending axis X2 of the plate portion 62b and the other end of the winding end 9 is provided at the corner portion N which is positioned at the end portion of the opposing surface 63a. Therefore, the distance from the opposing surface 63a corresponding to the corner portion N to the winding end 9, which is held between the opposing surfaces 63a and 63b, is shortened relative to a distance between the winding end 9 and the opposing surface 63. Thus, when fusing, the opposing surface 63a is prevented from being bent excessively to contact the opposing surface 63b, therefore a contact between the opposing surfaces 63a and 63b is surely prevented.

The terminal portion of the winding end 9 is provided at the groove 15a whose width is narrower than the diameter d of the terminal portion 9a of the winding end 9 and whose depth is deeper than the radius d/2 of the terminal portion 9a of the winding end 9. Therefore, the winding end 9 is fixed easily at the groove 15 and is easily connected to the opposing surfaces 63a and 63b by fusing.

Each of the winding start 8 and the winding end 9 of one of the coils 6 engage with each of the seat portion 13a and 13b whose heights are different from each other and the winding start 8 and the winding end 9 are wound thereat so as to be formed into the substantially U-shapes, to be substantially parallel or to extend outward, or to be formed substantially into the V-shapes. The end portions 8a and 9a of the winding start 8 and the winding end 9 are fixed at the grooves 14a and 15a, respectively, and then the fusing terminals 16 and 17 are formed by connecting the winding start 8 to the neutral fusing hook 93 and the winding end 9 to the first fusing hook 63 respectively. As a result, contact between the winding start 8 and the winding end 9 is prevented. Therefore, when shaken, a short circuit, which is a result of a peeling off of the insulator coating occurring when the winding start 8 and winding end 9 contact each other, is prevented and reliability of the motor 150 is enhanced. Further, two fusing terminals, the fusing terminal 16 and 17, are provided at both sides of one of the coils 6 of the electromagnet 1. Accordingly, a cost of the motor 150 is decreased compared to a motor in which one coil has one fusing terminal.

Accordingly, the winding end 9 is provided between the seat portion 13b and the groove 15a so as to incline therebetween and is held between the opposing surfaces 63a and 63b of the first fusing hook 63 and thus electrical connection between the winding end 9 and first bus ring 62 is established. Therefore, a distance between the opposing surfaces 63a and 63b of the first fusing hook 63 is maintained to be constant and the opposing surfaces 63a and 63b are prevented from contacting each other. As a result, the opposing surfaces 63a and 63b of the first fusing hook 63 and the winding end 9 are stably connected by fusing under a predetermined condition of fusing. The first fusing hook 63 includes a U-shaped end portion which extends from the first ring portion 62a of the first bus ring 62 to which the winding end 9 is electrically connected, towards the radial direction of the coil 6, so that a structure thereof is simplified compared to the known fusing structures. Further, a number of portions manufactured is reduced compared to structures of the know arts, and a process of pressing the end portions of the opposing surfaces 63a and 63b of the first fusing hook 63 against each other is not needed. Thus, the cost of manufacturing having the above-described fusing structure is decreased compared to the know fusing structures.

Accordingly, the first fusing hook 63 includes the free end which is bent, the winding end 9 is held between the opposing surfaces 63a and 63b formed by bending the plate portion 62b in order to form the bent free end and thus the electrical connection is established between the winding end 9 and the opposing surfaces 63a and 63b. In such a structure, the winding end 9 of the coil 6, provided between the free end of the opposing surfaces 63a and 63b, is held at a state where a distance between the winding end 9 and the opposing surfaces 63a and 63b is spaced away by the first fusing hook 63. As a result, the opposing surfaces 63a and 63b of the first fusing hook 63 and the winding end 9 are stably and sufficiently connected by fusing under the predetermined condition of fusing. In this case, a process of pressing the free ends of the first fusing hook 63 to the opposing surfaces 63a and 63b is not needed. Thus, the structure of the motor 150 is simplified and the cost of the fusing structure of the motor is reduced, compared to the known fusing structures.

According to the embodiment, the winding start 8 and the winding end 9 are arranged to incline at the opposing surfaces 63a and 63b and is held by means of the fusing hook 63, 73, 83 and 93 so as to extend towards an end portion of the free end

Accordingly, in this case, the winding end 9 is held by the first fusing hook 63 so as to incline at the opposing surfaces 63a and 63b and extend towards the end portion of the free end, so that the winding end 9 is fused to the opposing surfaces 63a and 63b more stably than the known fusing structures.

According to the embodiment, the fusing structure of a motor includes a seat portion for changing the direction of the end portion of the winding start 8 and the winding end 9.

Accordingly, the seat portions 13a and 13b are provided so as to prevent the winding start 8 and the winding end 9 from contacting each other and to stably change extending directions of the winding start 8 and the winding end 9 at predetermined positions.

According to the embodiment, the grooves 14a and 15a includes widths narrower than a diameter of the end portions of the winding start 8 and the winding end 9 and depths deeper than a radius of the end portions of the winding start and the winding end 9 so as to hold the end portions of the winding start 8 and the winding end 9.

According to the embodiment, the widths of the grooves 14a and 15a are narrower than the diameters of the winding start 8 and the winding end 9, respectively, and the depths of the grooves 14a and 15a are deeper than the radiuses of the winding start 8 and the winding end 9, respectively. The winding start 8 and the winding end 9 are fixed at the grooves 14a and 15a whose widths are narrower and whose depths are deeper than the diameters of the winding start 8 and the winding end 9, respectively. Therefore, winding start 8 and the winding end 9 are surely held at the grooves 14a and 15a.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the sprit of the present invention. Accordingly, it is expressly intended that all such variations, changes and equivalents which fall within the spirit and scope of the present invention as defined in the claims, be embraced thereby.

1. A fusing structure of a motor, comprising:
a stator including a stator core formed in a ring shape, a coil formed by winding a wire around the stator core via a bobbin and a bus ring connected to the stator core for supplying power to the coil; and
a rotor provided along an inner circumference of the stator and rotating relative to the stator when the coil is supplied with power from the bus ring, wherein
the bus ring comprises a ring portion and a fusing hook formed by bending a plate portion in a U-shape to form opposing surfaces being arranged in a radial direction of the motor, and
the bobbin comprises a first engagement portion for changing a direction of an end portion of the wire extending from the coil so as to supply the coil with the power and a second engagement portion guiding the end portion of the wire and formed in a different length from that of the first engagement portion in the radial direction of the motor, and wherein
the end portion of the wire is held between the first engagement portion and the second engagement portion so as to incline therebetween and held between the opposing surfaces of the fusing hook so as to establish an electrical connection with the bus ring.

2. A fusing structure of a motor, comprising:
a coil provided inside the motor; and
a fusing hook establishing a electrical connection with the end portion of the wire extending from the coil so as to supply power to the coil, wherein
a plate portion is bent to form a free end of the fusing hook and to hold the end portion of the wire between the opposing surfaces formed by bending the plate portion, thereby establishing an electrical connection between the opposing surfaces and the end portion of the wire.

3. The fusing structure of the motor according to claim 2, wherein the end portion of the wire is arranged to incline at the opposing surfaces and is held by means of the fusing hook so as to extend towards an end portion of the free end.

4. The fusing structure of the motor according to claim 1, wherein the first engagement portion includes a seat portion for changing the direction of the end portion of the wire.

5. The fusing structure of the motor according to claim 1, wherein the second engagement portion includes a width narrower than a diameter of the end portion of the wire and a depth deeper than a radius of the end portion of the wire so as to hold the end portion of the wire.
